(19) United States
(12) Patent Application Publication
(10) Pub. No.: US 2006/0242033 A1
(43) Pub. Date: Oct. 26, 2006

(54) Future value prediction

(75) Inventor: Steven Corbett, Bristol (GB)

Correspondence Address: BINGHAM MCCUTCHEN LLP, 3000 K STREET, NW, BOX IP, WASHINGTON, DC, 20007, US

(73) Assignee: Oracle International Corporation

(21) Appl. No.: 11/109,643

(22) Filed: Apr. 20, 2005

(51) Int. Cl. G06Q 99/00

(52) U.S. Cl. 705/28; 705/1

(57) ABSTRACT

A method of predicting a future value of a key performance indicator (KPI) is disclosed. The method comprises: a) retrieving, from a database, a data set from which the present KPI value can be derived; and b) operating on data extracted from the data set using a prediction algorithm to calculate the future value of the KPI.

This invention relates to a method and system for predicting a future value of a key performance indicator (KPI).

KPIs are used by an entity such as a company or a school to measure and monitor various aspects of the performance of their operation. A specific KPI is normally assigned a target value. For example, a school may wish to monitor the proportion of its pupils achieving a pass grade in examinations and may set a target value of 75%. Alternatively, a company may wish to monitor its profit margin, setting a target value of 30% for example.

If a KPI does not achieve its target value then an employee responsible for management of that aspect of an entity's operation would be expected to investigate the failure of performance, and preferably to take remedial action to correct it. However, there is a problem with this way of operation since by the time remedial action is instigated, the failure has already occurred.

In accordance with a first aspect of the present invention, there is provided a method of predicting a future value of a key performance indicator (KPI), the method comprising:

a) retrieving, from a database, a data set from which the present KPI value can be derived; and

b) operating on data extracted from the data set using a prediction algorithm to calculate the future value of the KPI.

In accordance with a second aspect of the present invention there is provided a system for predicting a future value of a key performance indicator (KPI), the system comprising a store for storing a data set from which the present KPI value can be derived, and a processor adapted to:

a) retrieve the data set from the store; and

b) operate on data extracted from the data set using a prediction algorithm to calculate the future value of the KPI.

Hence, the invention provides a method and system by which the future value of a KPI may be predicted so that remedial action can be taken if it appears that the future value of the KPI will fall below its target value, and such action can be taken before this has occurred. The invention thereby overcomes the problem of the prior art.

In one embodiment, the prediction algorithm is a linear regression algorithm.

In this case, the linear regression algorithm may operate on values of the data set representing past and present values of data from which the respective past and present values of the KPI can be derived.

Alternatively, the linear regression algorithm may operate on a pipeline data set retrieved from the database, the pipeline data set representing expected variations to future values of the data set from which the future value of the KPI will be derivable.

In a second embodiment, the prediction algorithm is a time-lag recurrent algorithm performed by a neural network.

The time-lag recurrent algorithm may operate on values of the data set representing past and present values of data from which respective past and present values of the KPI can be derived.

Alternatively, the time-lag recurrent algorithm may operate on a pipeline data set retrieved from the database. The pipeline data set representing expected variations to future values of the data set from which the future value of the KPI will be derivable.

In a third aspect of the present invention, a computer program comprises computer program code means adapted to perform the steps of the first aspect of the invention when said program is run on a computer.

In a fourth aspect, a computer program product comprises computer program code means adapted to perform the steps of the first aspect of the invention when said program is run on a computer.

Embodiments of the invention will now be described with reference to the accompanying drawings, in which:

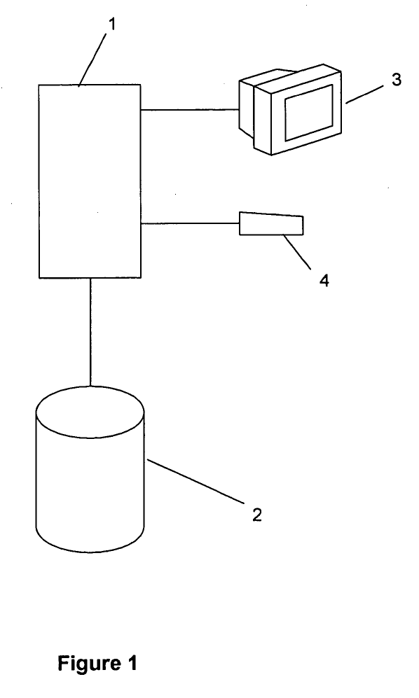

FIG. 1 shows a system adapted to perform the method of the invention;

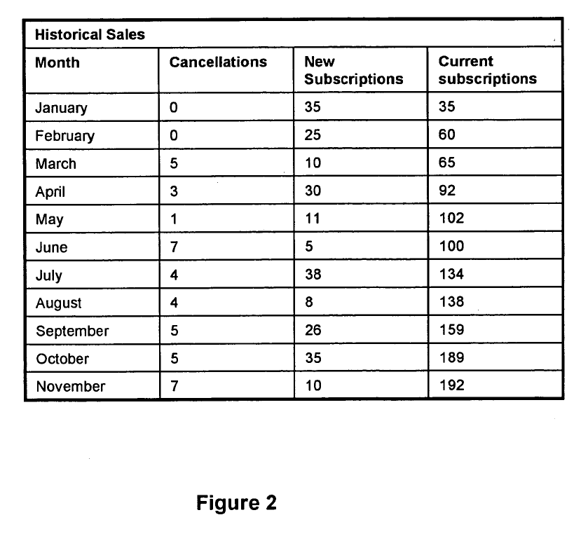

FIG. 2 shows an example data set;

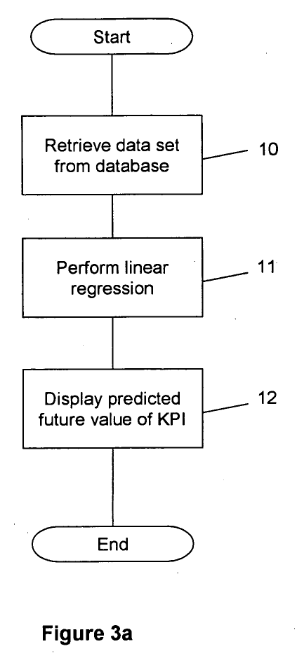

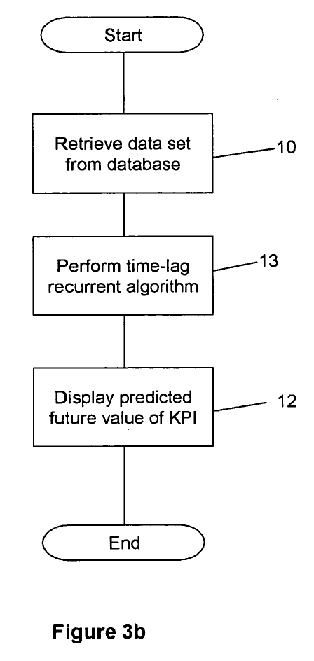

FIG. 3a shows a flowchart of the method of the first embodiment using a linear regression algorithm;

FIG. 3b shows a flowchart of the method of the first embodiment using the time-lag recurrent algorithm;

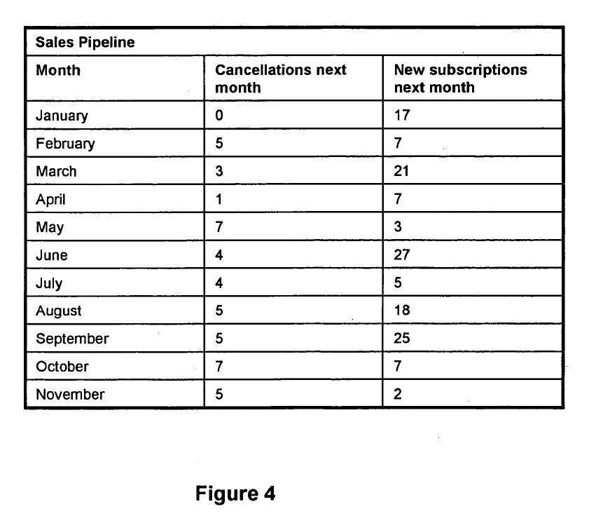

FIG. 4 shows example pipeline data;

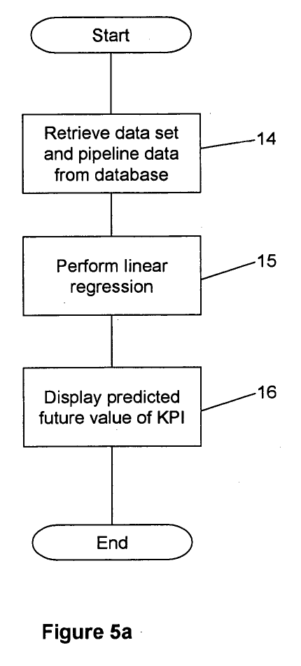

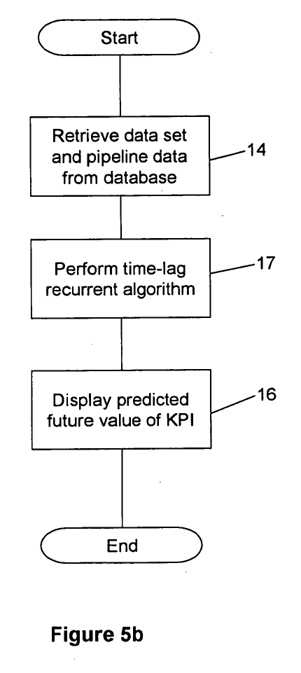

FIG. 5a shows a flowchart of the method of the second embodiment using a linear regression algorithm; and

FIG. 5b shows a flowchart of the method of the second embodiment using the time-lag recurrent algorithm.

FIG. 1 shows a schematic view of a system suitable for running software adapted to perform the invention. The system comprises a processor 1 connected to a store 2, such as a database, and to a display 3 and user input device 4.

FIG. 2 shows example data for a fictional company that produces a magazine. The data represent the sales of the company for the months of January to November in its first year of trading. Against each month are listed the number of subscription cancellations that have been made that month, the number of new subscriptions that have been made, and the current running total number of subscriptions. In any one month, the number of current subscriptions equals the number of subscriptions for the previous month added to the number of new subscriptions minus the number of cancellations. The company has set a target of having a total of 200 current subscriptions by the end of its first year of trading, and the following example shows how this value may be predicted using the historical sales data of FIG. 2.

FIG. 3a shows a flowchart of a method using linear regression by which the future value of the KPI (that is the number of current subscriptions for the month of December) maybe predicted. In step 10, the historical sales data set shown in FIG. 2 is retrieved from the database 2.

In step 11, the linear regression algorithm is performed on the data set of historical sales by assigning a period number to each month (i.e. January=1, February=2 etc). By using this period number and corresponding value for current subscriptions, a regression equation can be derived. This regression equation is:
y=15.5x+22.0
where: y=the predicted number of subscriptions for a period and x=the period number.

From this equation, a predicted value for the number of subscriptions that will have been made by December can be calculated. This value is 208 (since the period number for December is 12). The predicted future value is then displayed to a user in step 12. Since the value is greater than the target value of 200, the user will believe that the target is likely to be met.

FIG. 3b shows an alternative method for producing a predicted future value of the KPI. In this, step 11 of FIG. 3a is replaced by step 13 in which a time-lag recurrent algorithm is performed by a neural network which can be used to predict the future value of the KPI. This is expected to produce more accurate results than the linear regression algorithm.

FIG. 4 shows so-called sales pipeline data which may be used by the second embodiment. The sales pipeline data of FIG. 4 indicates against each month of January to November the number of cancellations that have been requested for the next month and the number of new subscriptions. Therefore, it can be seen that in the month of March, three cancellations have been requested to take effect in April and that there have been 21 new subscriptions.

FIG. 5a shows a flowchart of the method of the second embodiment. In step. 14, the data set of FIG. 2 and the pipeline data of FIG. 4 are retrieved from a database. The linear regression algorithm is then performed on these in step 15. In this case, the regression algorithm takes value pairs of the requested cancellations from FIG. 4 with the actual cancellations of FIG. 2. As can be seen, these two values are always equal (for example, FIG. 4 shows that five cancellations are requested in the month of February and there are actually five cancellations in the month of March as shown in FIG. 2). Thus, the regression formula is:
y₂=x₂
where: Y₂=the predicted number of cancellations for a month and x₂=the number of requested cancellations for the previous month.

Similarly, linear regression is used to compare the number of requested new subscriptions in FIG. 4 with the actual number of new subscriptions shown in FIG. 2. In this case, the regression algorithm will produce the following regression formula:
y₃=1.38x₃+0.88
where: y₃=the predicted number of new subscriptions for a month and x₃=the number of requested new subscriptions for the previous month.

These two formulae can be used in conjunction with the cancellations next month value for November of 5 and the new subscriptions next month value for November of 2 to predict a cancellation value of 5 and a new subscriptions value of 3 (when rounded down to the nearest whole number) for the month of December. When these values are added to the current subscriptions total for November of 192 this produces a predicted KPI value of 189. In this instance, it is predicted that the company will fail to achieve its target.

FIG. 5b shows an alternative method according to the second embodiment in which the linear regression algorithm in step 15 is replacement by a time-lag recurrent algorithm performed on a neural network in step 17. This is analogous to the method of FIG. 3b.

As can be seen, the invention has provided a method by which a future value of a KPI may be predicted in order to enable a company to take suitable remedial action before the KPI has actually failed to achieve its target. For instance, in the example of the second embodiment, the company may attempt to increase the actual value over the predicted value by instigating an advertising campaign or reducing their prices or by some other method.

It is important to note that while the present invention has been described in a context of a fully functioning data processing system, those of ordinary skill in the art will appreciate that the processes of the present invention are capable of being distributed in the form of a computer readable medium of instructions and a variety of forms and that the present invention applies equally regardless of a particular type of signal bearing media actually used to carry out distribution. Examples of computer readable media include recordable-type media such as floppy disks, a hard disk drive, RAM and CD-ROMs as well as transmission-type media such as digital and analogue communications links.

1. A method of predicting a future value of a key performance indicator (KPI), the method comprising:
a) retrieving, from a database, a data set from which the present KPI value can be derived; and
b) operating on data extracted from the data set using a prediction algorithm to calculate the future value of the KPI.

2. A method according to claim 1, wherein the prediction algorithm is a linear regression algorithm.

3. A method according to claim 2, wherein the linear regression algorithm operates on values of the data set representing past and present values of data from which respective past and present values of the KPI can be derived.

4. A method according to claim 2, wherein the linear regression algorithm operates on a pipeline data set retrieved from the database, the pipeline data set representing expected variations to future values of the data set from which the future value of the KPI will be derivable.

5. A method according to claim 1, wherein the prediction algorithm is a time-lag recurrent algorithm performed by a neural network.

6. A method according to claim 5, wherein the time-lag recurrent algorithm operates on values of the data set representing past and present values of data from which respective past and present values of the KPI can be derived.

7. A method according to claim 5, wherein the time-lag recurrent algorithm operates on a pipeline data set retrieved from the database, the pipeline data set representing expected variations to future values of the data set from which the future value of the KPI will be derivable.

8. A system for predicting a future value of a key performance indicator (KPI), the system comprising a store for storing a data set from which the present KPI value can be derived, and a processor adapted to:
a) retrieve the data set from the store; and
b) operate on data extracted from the data set using a prediction algorithm to calculate the future value of the KPI.

9. A system according to claim 8, wherein the prediction algorithm is a linear regression algorithm.

10. A system according to claim 9, wherein the linear regression algorithm operates on values of the data set representing past and present values of data from which respective past and present values of the KPI can be derived.

11. A system according to claim 9, wherein the linear regression algorithm operates on a pipeline data set retrieved from the database, the pipeline data set representing expected variations to future values of the data set from which the future value of the KPI will be derivable.

12. A system according to claim 9, wherein the prediction algorithm is a time-lag recurrent algorithm performed by a neural network.

13. A system according to claim 12, wherein the time-lag recurrent algorithm operates on values of the data set representing past and present values of data from which respective past and present values of the KPI can be derived.

14. A system according to claim 12, wherein the time-lag recurrent algorithm operates on a pipeline data set retrieved from the database, the pipeline data set representing expected variations to future values of the data set from which the future value of the KPI will be derivable.

15. A computer program comprising computer program code means adapted to perform the steps of claim 1 when said program is run on a computer.

16. A computer program product comprising computer program code means adapted to perform the steps of claim 1 when said program is run on a computer.
